(19) United States
(12) Patent Application Publication
(10) Pub. No.: US 2025/0093738 A1
(43) Pub. Date: Mar. 20, 2025

(54) GUIDANCE SYSTEM FOR A LASER BEAM

(71) Applicant: LASER ZENTRUM HANNOVER E.V., Hannover (DE)

(72) Inventor: Felix WELLMANN, Hannover (DE)

(21) Appl. No.: 18/832,636

(22) PCT Filed: Jan. 27, 2023
(86) PCT No.: PCT/EP2023/052009

§ 371 Date: Jul. 24, 2024

(30) Foreign Application Priority Data
Jan. 28, 2022 (DE) 10 2022 101 993.4
Feb. 1, 2022 (DE) 10 2022 102 298.6

(51) Int. Cl. G02F 1/33; G02B 26/10

(52) U.S. Cl. CPC G02F 1/33; G02B 26/105; G02F 2201/02; G02F 2203/24

(57) ABSTRACT

The invention relates to a guidance system for a laser beam for machining laser material, which comprises at least one deflection device by way of which the laser beam can be deflected, at least one supply line through which the laser beam can be fed to the deflection device, and at least one fiber array with a plurality of optical fibers, which is arranged in such a way that the laser beam is deflected by the deflection device onto a coupling surface of the fiber array, the deflection device comprising at least one non-mechanical deflection element.

The invention relates to a guidance system for a laser beam for laser material machining.

Nowadays lasers are used as an established tool in many fields of production and manufacturing. Laser beam sources, referred to in short as lasers, are used, for example, for automated cutting, welding, additive manufacturing, surface functionalization as well as for general machining of various materials, from glass, metal and polymers to composite materials. Laser beams enable high-precision material machining and are now seen as a tool for which there is no alternative in many industrial manufacturing applications. So-called laser scanners are often deployed, which move the laser beam in one or multiple spatial directions relative to a workpiece to be machined. In many applications, the limited relative speed between the laser beam and the workpiece poses a problem. The consequences of this limitation are limited machining speeds as well as thermally induced stresses due to uneven heat input in the workpiece being machined.

A guidance system for a laser beam is able to dynamically change the direction of propagation of a laser beam, i.e. to guide the laser beam in different directions at different times. This generally occurs without changing the direction of the laser beam from which it is fed to the guidance system. A static deflection, such as that caused by a stationary mirror, is not sufficient. If necessary, beam shaping can also be performed by the guidance system, which in some embodiments is also dynamic, i.e. variable over time. This is often advantageous, but not essential.

During two-dimensional machining with more than 1 kW laser output, commercially available galvanometer scanners enable scanning speeds of up to 50 m/s. This means that the light spot caused by the laser beam striking the workpiece moves across the surface of the workpiece at a maximum of this speed. Alternative technologies, such as polygon scanners, achieve significantly higher speeds of up to 1 km/s, but only enable one-dimensional machining with a constant speed of the light spot on the workpiece. The prior art contains no solution for multi-dimensional high-speed machining at several thousand m/s with galvanometer scanners and polygon scanners. Beam deflection systems that do not have accelerated mass-bearing components achieve very high beam deflection speeds of several km/s. However, the machining field is limited to a few mm² for the parameters commonly used when machining laser material.

Within the scope of the present invention, a laser is a device that emits coherent electromagnetic radiation, so-called laser radiation. The laser beam is the beam of light emitted by the laser, i.e. the electromagnetic radiation that propagates in a straight line. If the laser beam moves, the direction in which the electromagnetic radiation propagates changes. This means that the path along which the electromagnetic radiation moves changes and shifts over time.

The invention therefore aims to propose a guidance system for a laser beam for machining laser material that enables a higher deflection speed of the laser beam. In addition, the machining field should be designed to be as large as possible and can preferably be freely formed, for example as a line.

The invention solves the task addressed by way of a guidance system for a laser beam for machining laser material, which comprises at least one deflection device through which the laser beam can be deflected, at least one supply line through which the laser beam can be fed to the deflection device, and at least one fiber array with a plurality of optical fibers, which is arranged in such a way that the laser beam is deflected by the deflection device onto a coupling surface of the fiber array, the deflection device comprising at least one non-mechanical deflection element.

In the invention, a deflection device, with which a laser beam for machining laser material can be deflected, is consequently combined with at least one fiber array, which can also be referred to as a fiber bundle. Such a fiber bundle comprises a plurality of optical fibers into which the laser light can be coupled. To this end, the fiber array has a coupling surface, which is preferably composed of the coupling surfaces of the individual optical fibers of the fiber array. The guidance system is therefore based on fiber pixel-based control, wherein each optical fiber of the fiber array represents one pixel, and has significantly fewer beam sources, i.e. lasers, than controllable fiber channels. Each optical fiber of the fiber array forms an individual fiber channel. This applies in particular if an optical fiber contains precisely one core through which the laser light is guided. This is the case, for example, with some or all optical fibers. In other embodiments of the present invention, the fiber array has at least one, possibly multiple, multi-core fibers. In yet other embodiments, all optical fibers of the fiber array are designed as multi-core fibers. A multi-core fiber contains more than one core through which the laser light can be guided. If at least one such optical fiber is used in the fiber array, it is advantageous, but not essential, for each individual core of the multi-core fiber to constitute one individual fiber channel.

The deflection device is configured to deflect the laser beam entering through the supply line in a dynamic manner, i.e. varying over time, and to feed it, for example, to various optical fibers. In this case, the direction from which the laser beam is fed to the supply line or the direction of the supply line preferably does not change. The dynamic deflection is at least also, but preferably exclusively, caused by the deflection device. In preferred embodiments, the laser beam is successively fed to different optical fibers and/or different combinations of optical fibers by the deflection device by directing the laser beam onto the corresponding coupling surfaces and/or the corresponding section of a coupling surface. This should occur as quickly as possible. A laser beam is fed to the deflection device through the supply line from a supply direction and exits the deflection device along a deflection direction. At certain times, the latter can be identical or different to the supply direction. What is important is that an angle between the supply direction and the deflection direction changes over time and that this temporal change in the angle is caused by the deflection device.

The coupling surface of the fiber array can be designed as a single coupling surface or composed of a plurality of partial coupling surfaces. In this case, each optical fiber preferably has its own partial coupling surface which, in a simple embodiment, corresponds to the end face of the respective optical fiber.

At the end opposite the coupling surface, the individual optical fibers have at least one decoupling surface from which the laser beams coupled into the optical fibers are decoupled. This radiation can be directed by the optical fibers to the necessary point, so that the required deflection of the laser beam is no longer formed and achieved by the deflection device itself, but by the path covered by the optical fibers. Preferably, the decoupling surface is composed of multiple partial decoupling surfaces. The end faces of the individual optical fibers preferably constitute the partial decoupling surfaces. Alternatively, a substrate can be applied to individual, some or all of these end faces of the optical fibers, wherein the surface of said substrate that lies opposite the end faces then forms the decoupling surface or the partial decoupling surface for the optical fibers fixed to the substrate.

Since the deflection device has at least one non-mechanical deflection element, only a few, but preferably no masses at all have to be moved to deflect the laser beam. Consequently, it is particularly preferable if the deflection device does not have moving parts, such as mirrors, that have to be moved to deflect the laser beam.

Due to mass inertia, the feed speed in current laser beam guidance systems for machining laser material, which have moving parts, is limited. The use of non-mechanical deflection elements, which reach significantly higher deflection speeds, presents the possibility of further increasing the process speed. The consequences of low speed are low output (for example in roll-to-roll processes) or distortion of the printed component caused by thermal input (for example in LPBF (3D printing)).

Preferably, at least one non-mechanical deflection element has an acousto-optic deflector (AOD), by way of which the laser beam can be deflected. An acousto-optic deflector, also referred to as acousto-optic modulator (AOM), utilizes the acousto-optic effect. To this end, a piezoelectric transducer is fixed, for example, to a material that is transparent for the wavelength of the laser radiation, such as tellurium dioxide or quartz glass. An oscillating electrical signal causes the transducer to vibrate, thereby generating sound waves in the material. They are generated in a such a way that standing or travelling sound waves are formed in the material, which change the refractive index locally as density fluctuations. This results in a diffraction grating on which incident electromagnetic radiation, in this case the laser light of the laser beam, is diffracted. If the frequency of the sound waves generated varies, the diffraction pattern and therefore the deflection of the laser beam can be changed.

In this context, a distinction is often drawn between an acousto-optic modulator and an acousto-optic deflector, wherein the AOM is used as a switch that alternates between various diffraction orders of the laser light and the AOD can address multiple locations of a diffraction order, for example the first diffraction order. In both cases, the aforementioned acousto-optic effect is utilized.

Particularly preferably, the deflection device has two acousto-optical deflectors, each of which deflects the incident light in one spatial direction. The first deflector consequently deflects the laser beam in a first spatial direction. The second deflector deflects the laser beam in a second spatial direction. Preferably, the first spatial direction and the second spatial direction are perpendicular to each other, together creating a right angle. This is advantageous, but not essential. It is sufficient if the two spatial directions are linearly independent of one another. The two acousto-optical deflectors then render it possible to conduct a complete two-dimensional adjustment of the deflection of the laser beam.

Preferably, at least one non-mechanical deflection element has at least one acousto-optic deflector, by way of which the laser beam can be deflected. This process exploits the fact that certain materials exhibit an electro-optic effect, i.e. a change in the optical properties upon the influence of an electrical field. The Pockels effect and Kerr effect are stated as examples. In both examples, the refractive index of the respective material changes upon the influence of the electrical field by applying a voltage. A special non-linear electro-optical effect in specific, well-defined cut crystals of selected transparent materials is used to generate a linear refractive index gradient that is proportional to the applied signal voltage. When a laser beam passes perpendicular to the gradient, it is deflected, wherein the angle of deflection can be controlled by the externally applied voltage.

Particularly preferably, the deflection device has two electro-optical deflectors, each of which deflects the incident light in one spatial direction. The first deflector consequently deflects the laser beam in a first spatial direction. The second deflector deflects the laser beam in a second spatial direction. Preferably, the first spatial direction and the second spatial direction are perpendicular to each other, together creating a right angle. This is advantageous, but not essential. It is sufficient if the two spatial directions are linearly independent of one another. The two electro-optical deflectors then render it possible to conduct a complete two-dimensional adjustment of the deflection of the laser beam.

It is also conceivable that the deflection device has an electro-optical deflector and an acousto-optical deflector, each of which deflects the laser beam in one of the two spatial directions.

The at least one non-mechanical deflection element has at least one device for coherent beam combining. At least one laser beam, generated by at least one laser, is split into different parts, which are then combined and added together, possibly out of phase but coherently. The optical power of the parts can also be amplified, if necessary individually. The coherence of the respective parts leads to an interference, the effect of which depends of the phase shift. This also enables the spatial direction in which the constructive interference is formed, in which the laser beam extends, to be changed. This can also be combined with one or multiple electro-optical deflectors and/or with one or multiple acousto-optical deflectors.

In addition to the at least one non-mechanical deflection element, the deflection device preferably has at least one mechanical deflection element. The latter preferably comprises at least one galvanometer scanner and/or at least one polygon scanner, by way of which the laser beam can be deflected. Additionally or alternatively, at least one mechanical deflection element comprises a micro-electro-mechanical system, by way of which the laser beam can be deflected.

The guidance system preferably has a laser beam source.

The optical fibers of the fiber array preferably each have a decoupling surface, by way of which the coupled laser beams can be decoupled and that is arranged in such a way that decoupled laser beams are supplied to at least one laser material machining station. The latter may have a further deflection element, such as a polygon scanner. It is therefore advantageous if the laser radiation decoupled from the decoupling surface is fed to a further deflection device.

The fiber array preferably has a cross-sectional area of at least 5, preferably at least 10, more preferably at least 100, especially preferably at least 250 optical fibers per square centimeter on the coupling side and/or on the decoupling side. The optical fibers are preferably multimode fibers, single mode fibers, polarization-maintaining fibers, hollow-core fibers, PCF (Photonic Crystil Fiber), gradient index fibers, step index fibers, leakage channel fibers and/or multi-core fibers. It is particularly preferable if that density of the optical fibers on the decoupling side of the fiber array is lower than on the coupling side. Preferably, it is at least 0.2 fibers per square centimeter of cross-sectional surface. Even more preferably, it is at least 1, especially preferably at least 3 optical fibers per square centimeter of cross-sectional surface.

The decoupled laser beams that leave the decoupling surfaces of various optical fibers are preferably directed onto multiple workpieces for machining laser material or to multiple points of a workpiece for machining laser material of the workpiece. Due to the high speed and the switch rate of the guidance system, this results in almost simultaneous machining of the various points of the one workpiece or the multiple workpieces.

A substrate is preferably mounted, preferably welded or glued, to at least one part of the coupling surface, preferably the entire coupling surface, and/or at least one part of the decoupling surface, preferably all decoupling surfaces. In this case, a coupling surface is also understood to mean a partial coupling surface and a decoupling surface to also mean a partial decoupling surface.

The substrate is made of a material that is transparent for the laser radiation. In the process, the laser beams to be coupled into one or several of the optical fibers first enter the substrate. The beams are preferably designed to be converging within the substrate. This means that the cross section of the beam gets smaller as it passes through the substrate. As a result, the optical intensity at the interface between the air and the substrate decreases compared to the load at the interface between the air and the optical fibers without a substrate. Preferably, the surface of the substrate that lies opposite the coupling surface is provided with a coating which reduces the reflection of the laser radiation at the coupling surface.

Preferably, the entire coupling surface of the fiber array is fixed to the substrate. Alternatively, multiple substrates are provided, which are mounted on different parts of the coupling surface, preferably on different partial coupling surfaces. In one embodiment, an end face of each individual optical fiber forms a separate partial coupling surface, a substrate being fixed to each one.

The substrate, which is arranged on the decoupling surface, can preferably have a non-planar exit surface. This exit surface is preferably designed in such a way that the exiting laser beam is collimated or focussed. In particular, the exit surface of the substrate can be designed to be spherical or partially spherical. If multiple substrates are used, they can be designed to be identical or different. In particular, they can also be spherical.

The fiber array preferably has one optical fiber, wherein laser radiation can be fed to at least one beam trap through its decoupling surface. A beam trap is a device for absorbing electromagnetic radiation. For example, it is designed as a black cavity into which the radiation to be absorbed is directed. The beam trap is preferably cooled, for example using a water cooling system, in order to dissipate the heat introduced by the absorbed electromagnetic radiation. The laser beam can also be fed to a beam trap without an intermediate optical fiber. In this case, the laser radiation is fed directly from the deflection device to the beam trap.

The fiber array preferably has at least one optical fiber, wherein laser radiation can be fed by way of its decoupling surface to at least one sensor, in particular an intensity sensor and/or a power sensor. This allows the intensity and/or power of the laser radiation to be determined. Such a sensor is, for example, a CCD chip, a diode or a pyrometer. The sensor may also be a corresponding spatially resolved sensor.

Preferably, at least one cladding of the optical fibers is structured so that laser radiation coupled into the cladding exits at least partially, preferably completely, from the cladding. Here, the cladding may be the cladding of an individual optical fiber. Alternatively or additionally, the cladding can also be a cladding that encloses the entire fiber array or part of the fiber array, for example in the form of a glass capillary tube.

The invention also solves the addressed task by way of a fiber array for a guidance system described here.

A number of embodiment examples of the present invention will be explained in more detail with the aid of the accompanying drawings. They show:

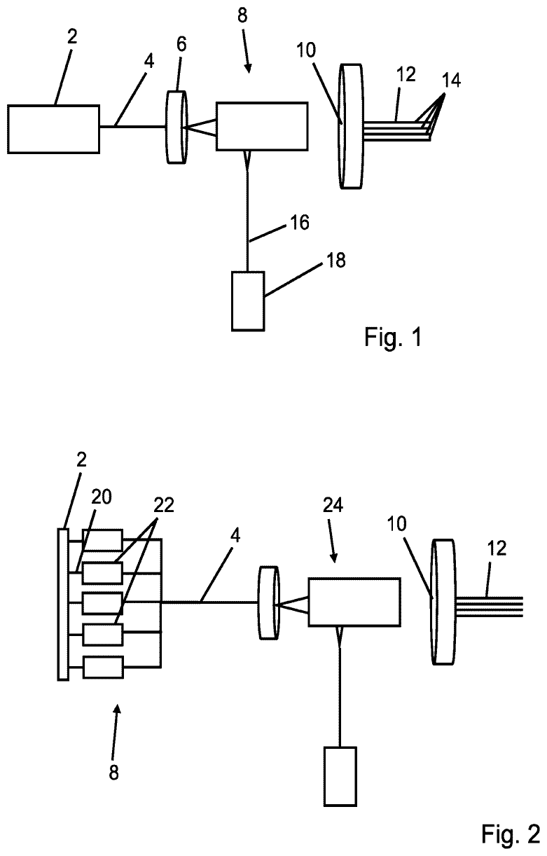

FIG. 1—the schematic representation of a guidance system according to one embodiment example of the present invention and

FIG. 2—the schematic representation of a guidance system according to a second embodiment example of the present invention.

FIG. 1 schematically depicts a guidance system according to a first embodiment example of the present invention. It has a laser beam source 2, which is configured to emit a laser beam 4. The laser beam 4 is fed via the supply line 6 to the actual deflection device 8. The latter has an acousto-optic deflector, an electro-optic deflector or another non-mechanical deflection element, by means of which the laser beam 4 is deflected. In the embodiment example shown, the deflection device 8 also has a device for optical beam shaping, which is known from the prior art. After leaving the deflection device 8, the laser beam 4 strikes a coupling surface 10 of a fiber array 12. The laser beam is then guided through the fiber array to the required point, which depends on which optical fiber 14 of the fiber array 12 the laser beam 4 is coupled into. A possible path for the laser beam 4 does not extend to the coupling surface 10 of the fiber array 12, but through a further light line 16 to a sensor 18.

FIG. 2 shows a different design of the present invention. The laser beam source 2 generates coherent electromagnetic radiation, which is divided into a plurality of individual beams 20. In the embodiment example shown, five individual beams 20 are depicted. However, this is only schematic and for the purposes of better visualization. The individual beams 20 are phase-shifted relative to each other by a fixed offset via phase elements 22 and then coherently superimposed. This causes interference between the individual beams 20. The result is constructive interference in spatial directions, which depend on the respective phase shifts of the individual beams 20 that have been superimposed. In the embodiment depicted in FIG. 2, the combination of phase elements 22 and coherent superimposition forms the deflection device 8.

After leaving said deflection device 8, the laser beam 4 strikes a beam forming device 24 before striking the coupling surface 10 of the fiber array 12.

At the opposite end, not depicted, of the individual optical fibers 14 of the fiber array 12 is a decoupling surface from which the laser radiation decouples from the individual optical fibers 14 and is fed to a further device.

### REFERENCE LIST

2 laser beam source
4 laser beam
6 supply line
8 deflection device
10 coupling surface
12 fiber array
14 optical fiber
16 light line
18 sensor
20 individual beam
22 phase element
24 beam shaping device

1. A guidance system for a laser beam for machining laser material, comprising:
at least one deflection device for deflecting the laser beam;
at least one supply for feeding the laser beam to the at least one deflection device; and
at least one fiber array comprising a plurality of optical fibers and a coupling surface, wherein said at least one fiber array is arranged such that the laser beam is deflected by the at least one deflection device onto the coupling surface of the fiber array,
wherein the at least one deflection device comprises at least one non-mechanical deflection element.

2. The guidance system according to claim 1, wherein the at least one non-mechanical deflection element comprises an acousto-optic deflector configured or configurable for deflecting the laser beam.

3. The guidance system according to claim 1 wherein the at least one non-mechanical deflection element comprises at least one electro-optic deflector configured or configurable for deflecting the laser beam.

4. The guidance system according to claim 1 wherein the at least one non-mechanical deflection element comprises a device for coherent beam combining.

5. The guidance system according to claim 1 wherein the at least one deflection device comprises at least one mechanical deflection element.

6. The guidance system according to claim 5, wherein the at least one mechanical deflection element comprises a galvanometer scanner configured or configurable for deflecting the laser beam.

7. The guidance system according to claim 5 wherein the at least one mechanical deflection element comprises a micro-electro-mechanical system configured or configurable for deflecting the laser beam.

8. The guidance system according to claim 1 further comprising at least one laser beam source for providing the laser beam to the at least one supply.

9. The guidance system according to claim 1 wherein the plurality of optical fibers of the at least one fiber array each have a decoupling surface for decoupling one or more coupled laser beams to produce one or more decoupled laser beams which are fed to at least one laser material machining station.

10. The guidance system according to claim 1 further comprising:
a decoupling surface associated with at least one of the plurality of optical fibers; and
a further deflection device,
wherein laser radiation decoupled from the decoupling surface is fed to the further deflection device.

11. The guidance system according to claim 1 wherein the at least one fiber array comprises at least 10 optical fibers.

12. The guidance system according to claim 1 wherein the at least one fiber array comprises at least 10 optical fibers per square centimeter of cross-sectional surface.

13. The guidance system according to claim 1 further comprising at least one substrate mounted to at least one part of the coupling surface.

14. The guidance system according to claim 1 wherein the at least one fiber array comprises at least one optical fiber which comprises a decoupling surface, wherein the at least one fiber array is configured or configurable such that laser radiation can be fed to a beam trap through the decoupling surface.

15. The guidance system according to claim 1 wherein the at least one fiber array comprises at least one optical fiber which comprises a decoupling surface, wherein the at least one fiber array is configured or configurable such that laser radiation can be fed by way of the decoupling surface to at least one sensor.

16. The guidance system according to claim 15, wherein only part of the laser radiation can be fed to the at least one sensor.

17. The guidance system according to claim 1 wherein at least one of the plurality of fibers comprises at least one cladding structured so that laser radiation coupled into the at least one cladding exits at least partially from the at least one cladding.

18. A fiber array configured for use as the at least one fiber array in the guidance system according to claim 1.

19. The guidance system according to claim 11 wherein the at least one fiber array comprises at least 100 optical fibers.

20. The guidance system according to claim 10 further comprising at least one substrate mounted to at least one part of the decoupling surface.
